(19) United States
(12) Patent Application Publication
(10) Pub. No.: US 2006/0044728 A1
(43) Pub. Date: Mar. 2, 2006

(54) Secondary protective element for secondary battery

(76) Inventors: Jun-Ho Kim, Asan-si (KR); Chan-Jung Kim, Cheonan-si (KR)

Correspondence Address: Robert E. Bushnell, Suite 300, 1522 K Street, N.W., Washington, DC, 20005, US

(21) Appl. No.: 11/191,232

(22) Filed: Jul. 28, 2005

(30) Foreign Application Priority Data
Jul. 28, 2004 (KR) 2004-0059430

(51) Int. Cl. H02H 5/04

(52) U.S. Cl. 361/103

(57) ABSTRACT

A secondary protective element includes: a functional element; a lead plate arranged on least one of upper and lower surfaces of the functional element; and at least one bending section arranged on a predetermined portion of the lead plate.

### CLAIM OF PRIORITY

This application makes reference to, incorporates the same herein, and claims all benefits accruing under 35 U.S.C. §119 from an application entitled SECONDARY PROTECTIVE ELEMENT FOR SECONDARY BATTERY, earlier filed in the Korean Intellectual Property Office on 28 Jul. 2004 and there duly assigned Serial No. 10-2004-0059430.

### BACKGROUND OF THE INVENTION

1. Field of the Invention

The present invention relates to a secondary protective element for a secondary battery, and more particularly to a secondary protective element for a secondary battery, in which a predetermined portion of lead plate of the secondary protective element includes a bending section which is bent when the secondary protective element is mounted on a secondary battery pack, thereby preventing the characteristics of the secondary protective element from being degraded.

2. Description of the Related Art

As generally known in the art, portable wireless appliances, such as video cameras, portable phones, and portable computers, have tended toward compactness and lightness while being equipped with high-grade functions, so various studies are being carried out with regard to secondary batteries, which are used for such potable wireless appliances as power sources. For instance, the secondary batteries include Ni—Cd batteries, Ni-MH batteries, Ni—Zn batteries and lithium secondary batteries. Among other things, the lithium secondary batteries are rechargeable batteries fabricated in a small size with mass storage. The lithium secondary batteries represent high operational voltage and high energy density per unit weight, so the lithium secondary batteries are extensively used in advanced electronic technology fields.

However, in such a lithium secondary battery, voltage can suddenly rise if an internal short circuit, an external short circuit or overcharge/over-discharge of an electrode assembly occurs in the lithium secondary battery. In this case, the lithium secondary battery can be broken. In order to prevent the short circuit from being created in the secondary battery, insulative tapes are attached not only to end portions of a positive electrode plate and a negative electrode plate of the electrode assembly, but also to a welding section of an electrode tap. In addition, the secondary battery is electrically connected to safety devices, such as a positive temperature coefficient (PTC) element, a secondary protective element including a thermal fuse, and a protective circuit. Such safety devices can shut off current when the voltage or temperature of the secondary battery suddenly rises, thereby preventing characteristics of the secondary battery from being degraded.

The secondary protective element can be a Positive Temperture Coefficient (PTC) element for the secondary battery. The secondary protective element includes a functional element and a lead plate. The secondary protective element is positioned closely adjacent to an outer surface of a can of the secondary battery. The secondary protective element detects temperature variation in the can so as to operate according to the temperature variation of the can.

The functional element has a PTC characteristic and is made of a resin-carbon composition including resin and carbon powder or is made of a ceramic. The functional element acts as a conductor under the normal temperature. However, if an ambient temperature around the function element 10 rises, the electrical resistance of the functional element increases in proportion to the ambient temperature, until the functional element acts as a non-conductor. Therefore, if the temperature in the can of the secondary battery rises due to a short circuit between the electrodes or an overcharge, the functional element detects it and shuts off current of the secondary battery, thereby protecting the secondary battery.

The lead plate has a plate shape and electrically makes contact with upper and lower surfaces of the functional element in such a manner that the functional device can be electrically connected to an electrode terminal of the secondary battery and a negative electrode input terminal of a protective circuit module. The secondary protective element can be aligned in various positions depending on the type of secondary battery. The present invention does not limit the secondary protective device to a part connected to the lead plate. For instance, the secondary protective element can be connected to a lower surface of the can and a positive input terminal of the protective circuit module according to the type of secondary battery.

The lead plate includes a first lead plate and a second lead plate, which are respectively connected to upper and lower surfaces of the functional element.

When the secondary protective element is aligned between the electrode terminal or a lower portion of the can and the protective circuit module, a predetermine portion of the lead plate must be bent away from the functional element by a predetermined distance. In more detail, if the bending section of the lead plate is closely adjacent to the functional element, stress is applied to the functional element, so the characteristics of the functional element can vary or the functional element can be damaged. For this reason, the lead plate is generally bent and welded in a position away from the functional element by a predetermined distance.

However, if the secondary battery pack is includes the secondary protective element, bending the lead plate and mounting of the secondary protective element must be performed within a narrow space, such that it is very difficult to bent the lead plate in a position away from the functional element by a predetermined distance. Therefore, the characteristics of the functional element can vary when mounting the functional element on the secondary battery pack.

### SUMMARY OF THE INVENTION

Accordingly, the present invention has been made to solve one or more of the above-mentioned problems occurring in the prior art, and the claimed invention is directed to providing a secondary protective element for a secondary battery, in which a lead plate of the secondary protective element is formed at a predetermined portion thereof with a bending section so that the bending section of the lead plate is bent when the secondary protective element is mounted on a secondary battery pack, thereby preventing characteristics of the secondary protective element from being degraded.

In order to accomplish this object, a secondary protective element is provided comprising: a functional element; a lead plate arranged on least one of upper and lower surfaces of the functional element; and at least one bending section arranged on a predetermined portion of the lead plate.

The functional element preferably comprises an element selected from the group consisting of a Positive Temperature Coefficient (PTC) element, a thermal fuse, and a thermal breaker.

The bending section is preferably spaced apart from the functional element by a predetermined distance. The predetermined distance is preferably at least 3 mm.

The bending section preferably comprises a groove arranged on both side ends of the lead plate. The groove preferably comprises a triangular or a semicircular cross-section. A width of the groove of the bending section is preferably within 25% of a width of the lead plate.

The bending section preferably comprises an aperture arranged on an inner portion of the lead plate. The bending section preferably comprises a square or oval shape, a rectangular shape, or a lozenge shape. The bending section preferably has a width within 1.0 mm and a length within 50% of a width of the lead plate. The bending section preferably comprises at least two apertures spaced apart from each other.

The bending section is preferably arranged on one surface of the lead plate with a groove. A length of the bending section is at least 50% of a width of the lead plate.

The bending section is preferably pressed on one surface of the lead plate. A length of the bending section is at least 50% of a width of the lead plate.

The bending section is preferably pressed on both surfaces of the lead plate. A depth of the bending section is preferably within 20% of a thickness of the lead plate.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a perspective view of a secondary protective element;

FIG. 2 is a perspective view of a secondary protective element according to a first embodiment of the present invention;

FIG. 3a is a plan view of a secondary protective element according to a second embodiment of the present invention;

FIG. 3b is a sectional view taken along ling A-A of FIG. 3a;

FIG. 4 is a plan view of a secondary protective element according to a third embodiment of the present invention;

FIG. 5a is a plan view of a secondary protective element according to a fourth embodiment of the present invention;

FIG. 5b is a sectional view taken along ling B-B of FIG. 5a;

FIG. 6a is a plan view of a secondary protective element according to a fifth embodiment of the present invention;

FIG. 6b is a sectional view taken along ling C-C of FIG. 6a;

FIG. 7 is a plan view of a secondary protective element according to a sixth embodiment of the present invention;

FIG. 8 is a sectional view of a secondary protective element according to a seventh embodiment of the present invention; and

FIG. 9 is a front view of a can type lithium-ion secondary battery equipped with a secondary protective element according to the present invention.

### DETAILED DESCRIPTION OF THE INVENTION

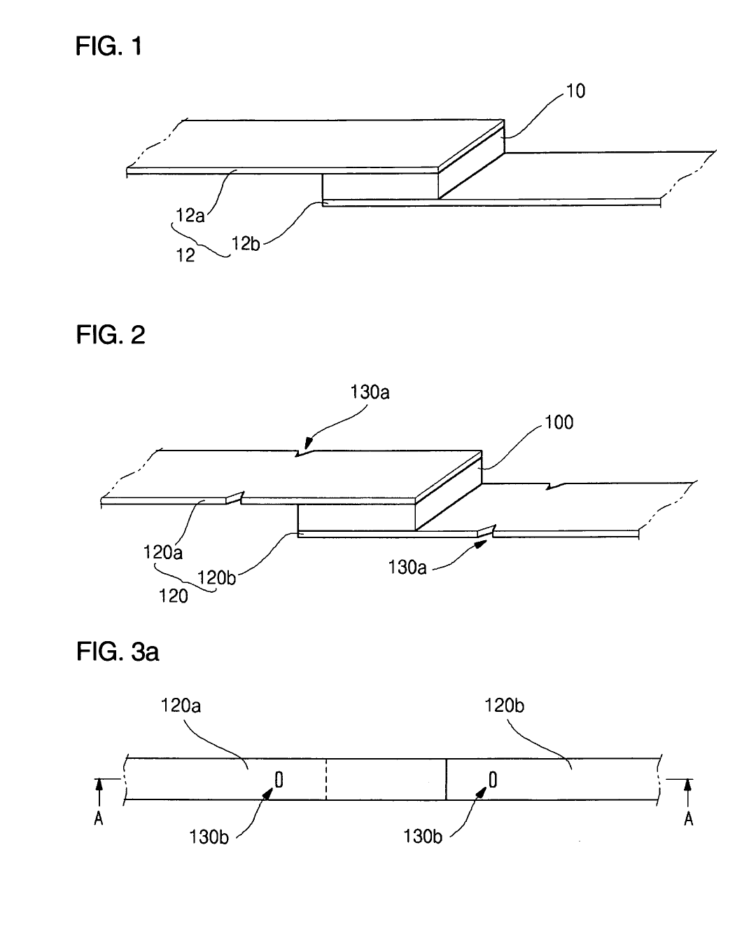

FIG. 1 is a perspective view of a secondary protective element for a secondary battery.

The secondary protective element is a Positive Temperture Coefficient (PTC) element for the secondary battery. Referring to FIG. 1, the secondary protective element includes a functional element 10 and a lead plate 12. The secondary protective element is positioned closely adjacent to an outer surface of a can of the secondary battery. The secondary protective element detects temperature variation in the can so as to operate according to the temperature variation of the can.

The functional element 10 has a PTC characteristic and is made of a resin-carbon composition including resin and carbon powder or is made of a ceramic. The functional element 10 acts as a conductor under the normal temperature. However, if an ambient temperature around the function element 10 rises, the electrical resistance of the functional element 10 increases in proportion to the ambient temperature, until the functional element 10 acts as a non-conductor. Therefore, if the temperature in the can of the secondary battery rises due to a short circuit between the electrodes or an overcharge, the functional element 10 detects it and shuts off current of the secondary battery, thereby protecting the secondary battery.

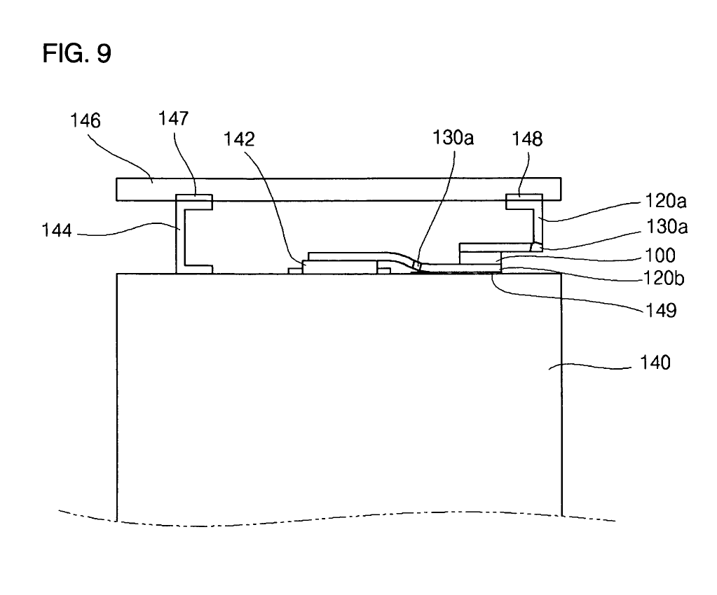

The lead plate 12 has a plate shape and electrically makes contact with upper and lower surfaces of the functional element 10 in such a manner that the functional device 10 can be electrically connected to an electrode terminal (see FIG. 9) of the secondary battery and a negative electrode input terminal (see FIG. 9) of a protective circuit module. The secondary protective element can be aligned in various positions depending on the type of secondary battery. The present invention does not limit the secondary protective device to a part connected to the lead plate. For instance, the secondary protective element can be connected to a lower surface of the can and a positive input terminal of the protective circuit module according to the type of secondary battery.

The lead plate 12 includes a first lead plate 12a and a second lead plate 12b, which are respectively connected to upper and lower surfaces of the functional element 10.

When the secondary protective element is aligned between the electrode terminal or a lower portion of the can and the protective circuit module, a predetermine portion of the lead plate 12 must be bent away from the functional element 10 by a predetermined distance. In more detail, if the bending section of the lead plate 12 is closely adjacent to the functional element 10, stress is applied to the functional element 10, so the characteristics of the functional element 10 can vary or the functional element 10 can be damaged. For this reason, the lead plate 12 is generally bent and welded in a position away from the functional element 10 by a predetermined distance.

Hereinafter, embodiments of the present invention are described with reference to the accompanying drawings. In the following description and drawings, the same reference numerals are used to designate the same or similar components, and a repetition of their description has been omitted.

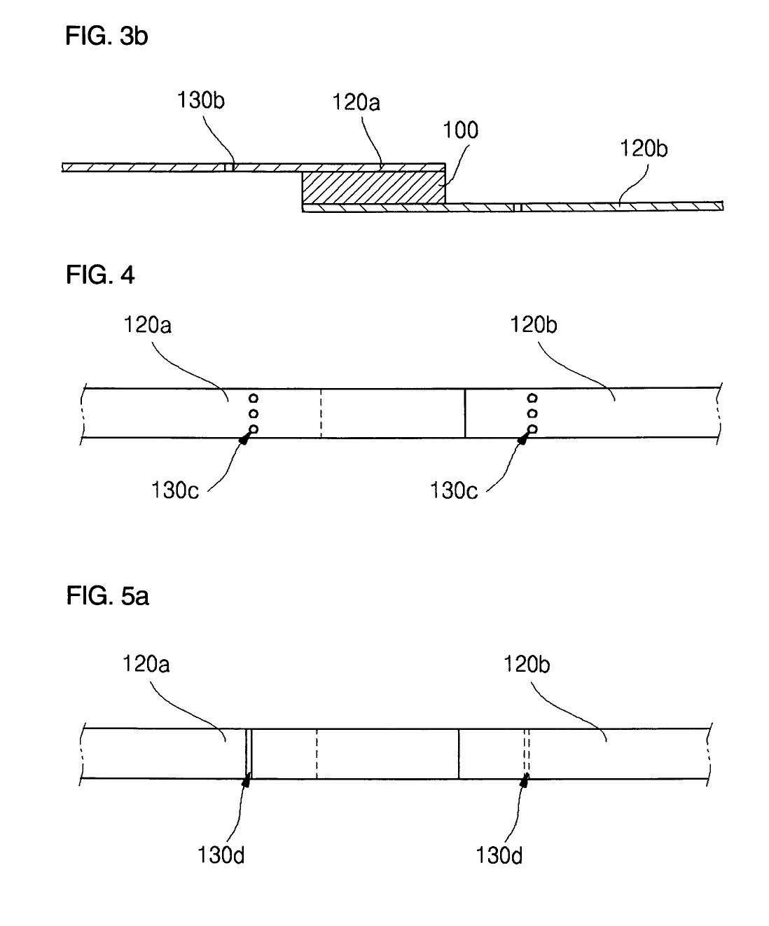

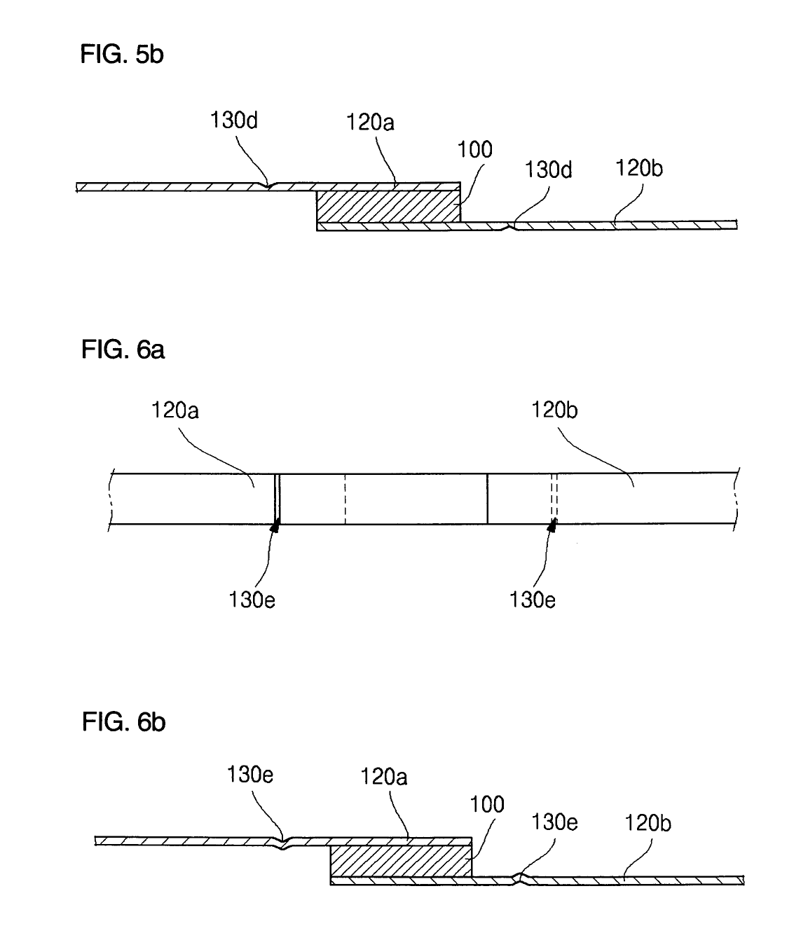

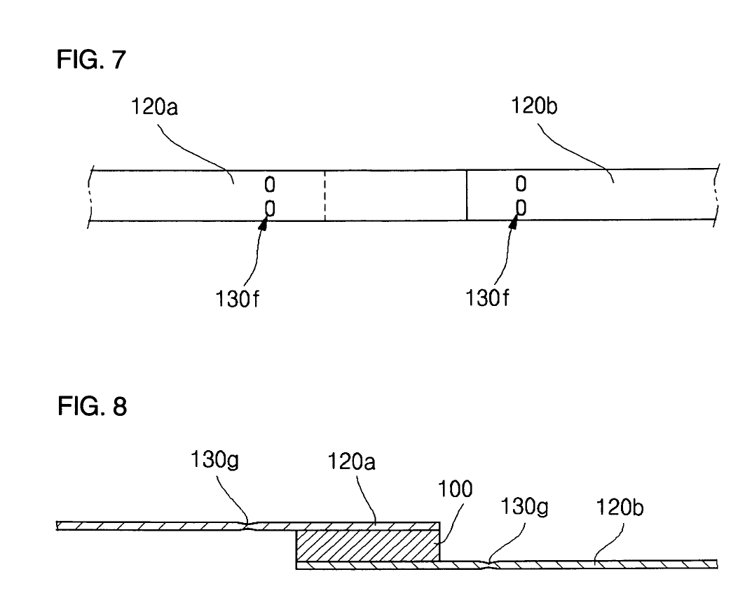

FIG. 2 is a perspective view of a secondary protective element according to a first embodiment of the present invention, FIG. 3a is a plan view of a secondary protective element according to a second embodiment of the present invention, FIG. 3b is a sectional view taken along ling A-A of FIG. 3a, FIG. 4 is a plan view of a secondary protective element according to a third embodiment of the present invention, FIG. 5a is a plan view of a secondary protective element according to a fourth embodiment of the present invention, FIG. 5b is a sectional view taken along ling B-B of FIG. 5a, FIG. 6a is a plan view of a secondary protective element according to a fifth embodiment of the present invention, FIG. 6b is a sectional view taken along ling C-C of FIG. 6a, FIG. 7 is a plan view of a secondary protective element according to a sixth embodiment of the present invention, FIG. 8 is a sectional view of a secondary protective element according to a seventh embodiment of the present invention, and FIG. 9 is a front view of a can type lithium-ion secondary battery equipped with a secondary protective element according to the present invention.

Referring to FIG. 2, the secondary protective element according to the present invention includes a functional element 100, a lead plate 120 and a bending section 130a.

As described above, the functional element 100 has a PTC characteristic and is made of resin-carbon composition including resin and carbon powder or is made of a ceramic. The functional element 100 can act as a conductor under normal temperature. However, if an ambient temperature around the functional element 100 rises, the electrical resistance of the functional element 100 increases in proportion to the ambient temperature until the functional element 100 acts as a non-conductor. Therefore, if the temperature in the can of the secondary battery rises due to a short circuit between the electrodes or an overcharge, the functional element 100 detects it and shuts off the current of the secondary battery, thereby protecting the secondary battery. Besides the PTC element, a thermal fuse or a thermal breaker can be used as the functional element 100.

The lead plate 120 has a plate shape and includes a first lead plate 120a and a second lead plate 120b, which are respectively connected to upper and lower surfaces of the functional element 100. According to another embodiment of the present invention, only one lead plate is connected to one of the upper and lower surfaces of the functional element 100.

The lead plate 120 electrically contacts the upper and lower surfaces of the functional element 100 in such a manner that the functional device 100 can be electrically connected to the secondary battery. For instance, the lead plate 120 connects the secondary protective element to an electrode terminal (see, FIG. 9) formed on an upper portion of the can and a negative electrode input terminal (see, FIG. 9) of a protective circuit module. In addition, the lead plate 120 connects the secondary protective element to a lower surface of the can and a positive input terminal of the protective circuit module according to the sort of the secondary batteries. That is, the secondary protective element can be aligned in various positions in the secondary battery pack depending on the type of secondary battery. The present invention does not limit the mounting position of the secondary protective device.

According to the first embodiment of the present invention, as shown in FIG. 2, the lead plate 120 includes a bending section 130a formed at a predetermined portion of the lead plate 120 while being spaced from the functional element 100. The bending section 130a guides the bending position of the lead plate 120 in such a manner that the lead plate 120 can be bent about the bending section 130a. Preferably, the bending section 130a is spaced from the functional element 100 by at least 2 mm. If the distance between the bending section 130a and the function element 10 is shorter than 3 mm, the characteristics of the functional device 100 can be degraded while bending the lead plate 120.

The bending section 130 can be formed on at least one of the first lead plate 120a and the second lead plate 120b according to the shape of the secondary battery pack on which the secondary protective element is mounted. The bending section 130a can be formed with various shapes and sizes. Since the lead plate 120 is made of a thin metal plate having the thickness smaller than 0.5 mm, the lead plate 120 is mechanically weak. Therefore, it is necessary to prevent a negative electrode tab from being weakened by the bending section 130a.

The bending section 130a is formed at both lateral sides of the lead plate 120 corresponding to the bending position of the lead plate 120. The bending section 130a has a triangular groove shape or a semicircular groove shape. However, the present invention does not limit the shape of the bending section 130a. In addition, since the bending section 130a guides the lead plate 120 such that a predetermined portion of the lead plate 120 can be bent, the bending section 130a is formed with a predetermined size sufficient for bending the lead plate 120. Preferably, a length of the bending section 130a is within 25% of a width of the lead plate 120 so as to prevent the lead plate 120 from weakening, thereby preventing the lead plate 120 from being broken during bending or following processes.

According to the second embodiment of the present invention as shown in FIGS. 3a and 3b, a bending section 130b including an elongated aperture having a predetermined width and a predetermined length is formed in bending positions of the lead plate 120. The bending section 130b can be formed with various shapes, such as a square or oval shape, a rectangular shape, or a lozenge shape. The present invention does not limit the shape of the bending section 130b. In addition, since the bending section 130b guides the lead plate 120 such that a predetermined portion of the lead plate 120 can be bent, the bending section 130b is formed with a predetermined size sufficient for bending the lead plate 120. Preferably, a width of the bending section 130b is within 1.0 mm, and a length of the bending section 130b is within 50% of a width of the lead plate 120 so as to prevent the lead plate 120 from weakening, thereby preventing the lead plate 120 from being broken during bending or following processes.

According to the third embodiment of the present invention, as shown in FIG. 4, bending sections 130c including at least two apertures are formed widthwise along the lead plate 120 while forming a predetermined interval therebetween. Preferably, a diameter or a width of the bending section 130c is within 1.0 mm so as to so as to prevent the lead plate 120 from weakening, thereby preventing the lead plate 120 from being broken during bending or following processes.

It is also possible to provide the bending section by combining the bending sections of FIGS. 2 and 3a or the bending sections of FIGS. 2 and 4.

According to the fourth embodiment of the present invention, as shown in FIGS. 5a and 5b, bending sections 130d are provided along bending lines of the lead plate 120 in the form of grooves. Preferably, a depth of the bending section 130d is within 20% of the thickness of the lead plate 120 so as to prevent the lead plate 120 from being broken during bending or following processes. The length of the bending section 130d is at least 50% of a width of the lead plate 120. Preferably, the length of the bending section 130d is equal to the width of the lead plate 120. The bending section 130d has a groove of a shallow depth. Accordingly, the bending section 130d must have a length that is more than 50% of the width of the lead plate 120 in order to guide the bending for the lead plate 120.

According to the fifth embodiment of the present invention, as shown in FIGS. 6a and 6b, bending sections 130e are provided along bending lines of the lead plate 120 by linearly pressing predetermined portions of the lead plate 120. Accordingly, protrusions are formed in the lead plate 120. The length of the bending section 130e is at least 50% of a width of the lead plate 120. Preferably, the length of the bending section 130e is equal to the width of the lead plate 120. Since, the bending section 130e is formed by pressing, it has a shallow depth. Accordingly, the bending section 130e must have a length that is more than 50% of the width of the lead plate 120 in order to guide the bending for the lead plate 120.

According to the sixth embodiment of the present invention, as shown in FIG. 7, bending sections 130f including at least two apertures having a predetermined length are irregularly provided along bending lines of the lead plate 120. The apertures of the bending section 130f can be formed by scratching or pressing as described with reference to FIGS. 5a and 5b. The present invention does not limit the diameter of each aperture. Preferably, the diameter of each aperture of the bending section 130f is at least 50% of the width of the lead plate 120.

According to the seventh embodiment of the present invention, as shown in FIG. 8, bending sections 130g are formed at both surfaces of the lead plate 120 with a predetermined depth by pressing predetermined portions of the lead plate 120 along bending lines of the lead plate 120. The depth of the bending section 130g is within 20% of the thickness of the lead plate 120 in order to prevent the lead plate 120 from being broken during bending or following processes. The length of the bending section 130g is at least 50% of a width of the lead plate 120. Preferably, the length of the bending section 130g is equal to the width of the lead plate 120.

As mentioned above, the bending sections can be formed of various shapes, and the present invention does not limit the shapes of the bending section, if the bending sections can allow the lead plate to be bent at predetermined portions thereof.

In addition, although that the bending sections 130a to 130g are simultaneously formed in the first and second lead plates 120a and 120b in the examples above, the bending sections 130a to 130g can be selectively formed on one of the first and second lead plates 120a and 120b according to the position of the secondary protective element.

Hereinafter, an operation of the secondary protective element according to the present invention is described with reference to FIG. 9.

FIG. 9 is a front view of a can type lithium-ion secondary battery equipped with a secondary protective element having the bending sections according to the present invention.

As shown in FIG. 9, the can type lithium-ion secondary battery includes a can 140, an electrode assembly (not shown) accommodated in the can 140, and a cap assembly (not shown) coupled with an upper portion of the can 140 and electrically connected to the electrode assembly. In addition, the can type lithium-ion secondary battery includes a protective circuit module 146 formed at the upper portion of the can 140. Secondary protective elements 100, 120a and 120b are electrically connected between an electrode terminal 142 protruding from the upper portion of the can 140 and a negative electrode terminal 148 of the protective circuit module 146 by welding or soldering. In addition, the can 140 is electrically connected to a positive electrode terminal 147 of the protective circuit module 146 through a separate lead wire 144. Since a space formed between the can 140 and the protective circuit module 146 is very small, the first and second lead plates 120a and 120b of the secondary protective elements are bent at predetermined portions thereof. The first and second lead plates 120a and 120b are always bent at the bending sections 130a thereof so that the first and second lead plates 120a and 120b have constant bending positions. Therefore, operational characteristics and functions of the functional element 100 of the secondary protective element cannot be degraded. In addition, the bending of the first and second lead plates 120a and 120b of the secondary protective element can be simplified. The secondary protective element is insulated from the upper portion of the can 140 by a separate insulating layer 149.

As described above, according to the secondary protective element of the present invention, the bending sections are formed at predetermined portions of the first and second lead plates of the secondary protective element so that the first and second lead plates are always bent at the bending sections thereof, thereby preventing operational characteristics and functions of the functional element 100 of the secondary protective element from being degraded.

In addition, according to the present invention, the bending sections formed in the lead plate of the secondary protective element can facilitate the bending of the lead plate, so process time for bending the lead plate can be shortened and the bending positions can be concentrated on predetermined portions of the lead plate.

Although a exemplary embodiments of the present invention have been described for illustrative purposes, those skilled in the art will appreciate that various modifications, additions and substitutions are possible, without departing from the scope and spirit of the invention as recited in the following claims.

What is claimed is:

1. A secondary protective element, comprising:
a functional element;
a lead plate arranged on least one of upper and lower surfaces of the functional element; and
at least one bending section arranged on a predetermined portion of the lead plate.

2. The secondary protective element as claimed in claim 1, wherein the functional element comprises an element selected from the group consisting of a Positive Temperature Coefficient (PTC) element, a thermal fuse, and a thermal breaker.

3. The secondary protective element as claimed in claim 1, wherein the bending section is spaced apart from the functional element by a predetermined distance.

4. The secondary protective element as claimed in claim 3, wherein the predetermined distance is at least 3 mm.

5. The secondary protective element as claimed in claim 1, wherein the bending section comprises a groove arranged on both side ends of the lead plate.

6. The secondary protective element as claimed in claim 5, wherein the groove comprises a triangular or a semicircular cross-section.

7. The secondary protective element as claimed in claim 6, wherein a width of the groove of the bending section is within 25% of a width of the lead plate.

8. The secondary protective element as claimed in claim 1, wherein the bending section comprises an aperture arranged on an inner portion of the lead plate.

9. The secondary protective element as claimed in claim 8, wherein the bending section comprises a square or oval shape, a rectangular shape, or a lozenge shape.

10. The secondary protective element as claimed in claim 9, wherein the bending section has a width within 1.0 mm and a length within 50% of a width of the lead plate.

11. The secondary protective element as claimed in claim 8, wherein the bending section comprises at least two apertures spaced apart from each other.

12. The secondary protective element as claimed in claim 1, wherein the bending section is arranged on one surface of the lead plate with a groove.

13. The secondary protective element as claimed in claim 12, wherein a length of the bending section is at least 50% of a width of the lead plate.

14. The secondary protective element as claimed in claim 1, wherein the bending section is pressed on one surface of the lead plate.

15. The secondary protective element as claimed in claim 14, wherein a length of the bending section is at least 50% of a width of the lead plate.

16. The secondary protective element as claimed in claim 1, wherein the bending section is pressed on both surfaces of the lead plate.

17. The secondary protective element as claimed in claim 16, wherein a depth of the bending section is within 20% of a thickness of the lead plate.
